(19) United States
(12) Patent Application Publication
(10) Pub. No.: US 2026/0323280 A1
(43) Pub. Date: Oct. 15, 2026

(54) METHODS, ARCHITECTURES, APPARATUSES AND SYSTEMS FOR DYNAMIC CONSENT MECHANISMS FOR WIRELESS NETWORKS

(71) Applicant: InterDigital Patent Holdings, Inc., Wilmington, DE (US)

(72) Inventors: Laksh Bhatia, London (GB); Magurawalage Chathura Madhusanka Sarathchandra, London (GB); Samir Ferdi, Kirkland (CA); Michel Roy, Candiac (CA)

(21) Appl. No.: 19/178,414

(22) Filed: Apr. 14, 2025

(51) Int. Cl. H04W 12/0431; H04W 12/041; H04W 12/06; H04W 12/106

(52) U.S. Cl. CPC H04W 12/0431; H04W 12/041; H04W 12/06; H04W 12/106

(57) ABSTRACT

Procedures, methods, architectures, apparatuses, systems, devices, and computer program products are provided for managing consent for a wireless transmit/receive unit (WTRU) to perform a task. WTRU methods and systems include generating a consent token associated with a network-controlled operation. The methods and systems further include the WTRU transmitting the consent token to a wireless network and receiving a request, from the wireless network, indicating the consent token and whether to perform the network-controlled operation. The request may further indicate metadata provided by an application function of the wireless network. The methods and systems further include the WTRU verifying whether the request indicating the consent token is valid. The methods and systems additionally include the WTRU, based on determining that the request is valid, performing the network-controlled operation.

### TECHNICAL FIELD

The present disclosure is generally directed to the fields of communications, software and encoding/decoding, including, for example, to methods, architectures, apparatuses, systems related to managing consent for a device to perform a task.

### BACKGROUND

Devices (e.g., wireless transmit/receive units) that are communicatively coupled to a wireless network may be configured to provide consent to a wireless network in order to perform a task such as positioning.

### SUMMARY

Consent to perform a network-controlled operation may be static. For example, consent may need to be obtained from a user of a wireless transmit/receive unit (WTRU), and explicit user consent may be required to approve updates or revocations to certain aspects of consent. Consent may be provided by an application function from a service provider that deploys or manages WTRUs. Application functions may provide a way for core networks to use one or more WTRUs managed by the application functions to perform a network controlled operation. Accordingly, systems and methods are desired for dynamically managing consent via an application function.

In accordance with certain embodiments of the present disclosure, methods and systems are provided for operating a WTRU. The methods include a WTRU generating a consent token associated with a network-controlled operation. In certain representative embodiments, the network-controlled operation may be related to any one or more of sensing, computing, data collection, artificial intelligence, or machine learning. The methods also include the WTRU transmitting the consent token to a wireless network. The methods further include the WTRU receiving a request, from the wireless network, indicating the consent token and whether to perform the network-controlled operation. In certain representative embodiments, the consent token may be fully included in the request. In certain representative embodiments, the request may indicate the consent token by referencing some aspect of the consent token. In certain representative embodiments, the request further indicates metadata provided by a network entity (e.g., an application function). The methods additionally include the WTRU verifying whether the request indicating the consent token is valid (e.g., by verifying a message authentication code using a key shared between a WTRU and a network entity). The methods further include the WTRU, based on determining that the request is valid, performing the network-controlled operation.

In certain representative embodiments, the consent token or the metadata provided by a network entity may indicate any one or more of the following: information of a type of network-controlled operation that the consent token is associated with; configuration information associated with the WTRU; target sensing service area related information; time validity related information; pricing related information; acceptable data type information; bandwidth availability information; data storage configuration information; data sharing configuration information; a message authentication code such that the message authentication code is shared between the WTRU and the wireless network to verify at least one of authenticity or integrity of the consent token; application function identifying information; information specifying one or more networks the consent token is valid for; WTRU identification information; or service correlation identifying information where the service correlation identifying information indicates one or more ongoing or previous network-controlled operations the WTRU is suitable for.

Furthermore, in accordance with certain embodiments of the present disclosure, a wireless network entity is configured to coordinate network-controlled operations. The wireless network entity is configured to receive a consent token from an application function, where the consent token is associated with a WTRU. The wireless network entity is also configured to verify, based on information from the application function, at least one of authenticity or integrity of the consent token. The wireless network entity is also configured to receive a first request to perform a network-controlled operation. In certain representative embodiments, the first request is received from the application function or is received from a second wireless network entity. The wireless network entity is additionally configured to determine that the consent token provides consent for the network-controlled operation to be performed by the WTRU. The wireless network entity is moreover configured to transmit a second request indicating the consent token the WTRU to perform the network-controlled operation.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 1E is a pair of illustrative block diagrams of components implementing the features of a sensing coordination function and a sensing analytics function, in accordance with certain embodiments;

FIG. 2 is a diagram illustrating how an application may provide consent to a 3GPP network to utilize one or more WTRUs associated with the application, in accordance with certain embodiments;

FIG. 3 is a diagram illustrating how a 3GPP network enables an application to use the WTRUs of another application, in accordance with certain embodiments;

FIG. 4 is a diagram illustrating two applications that do not have a trustworthy relationship with respect to one another but have a trustworthy relationship with an associated 3GPP network, in accordance with certain embodiments;

FIG. 5 is a diagram illustrating a procedure for user-consent collection initiated by an application function, in accordance with certain embodiments;

FIG. 6 is a diagram illustrating a procedure where a network function of a core network sends a request to an application function to use one or more WTRUs for some network-controlled operation, in accordance with certain embodiments;

FIG. 7 is a diagram illustrating a procedure where a network function verifies the authenticity and integrity of a consent token, in accordance with certain embodiments;

FIG. 8 is a diagram illustrating a procedure for revoking or updating a currently used consent token, in accordance with certain embodiments;

FIG. 9 is a flowchart of an illustrative method performed by a WTRU for performing a network-controlled operation based on a consent token, in accordance with certain embodiments; and

FIG. 10 is a flowchart of an illustrative method performed by a wireless network entity for coordinating a network-controlled operation based on a consent token, in accordance with certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

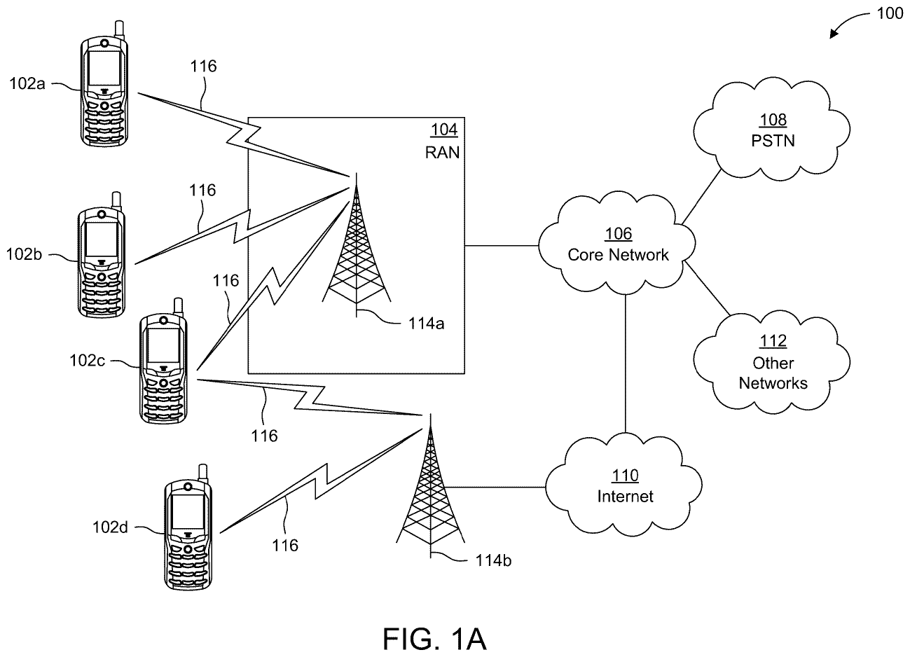

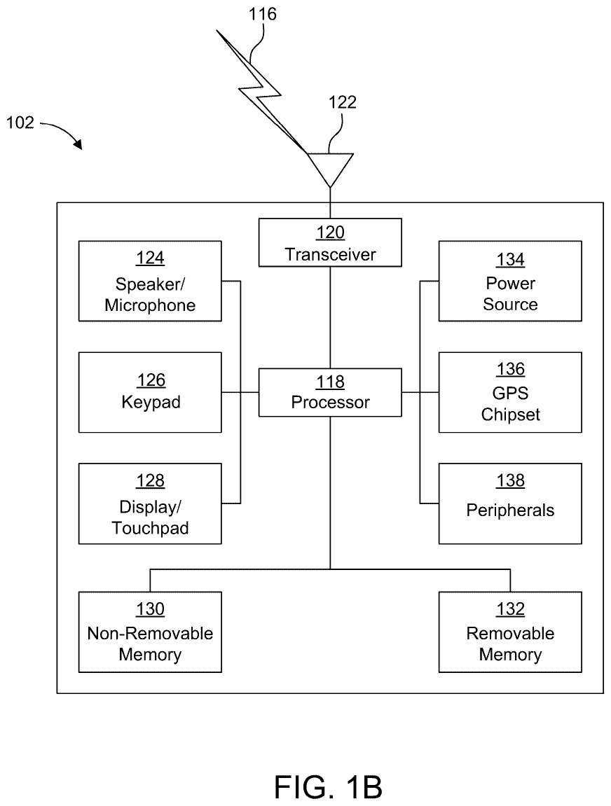

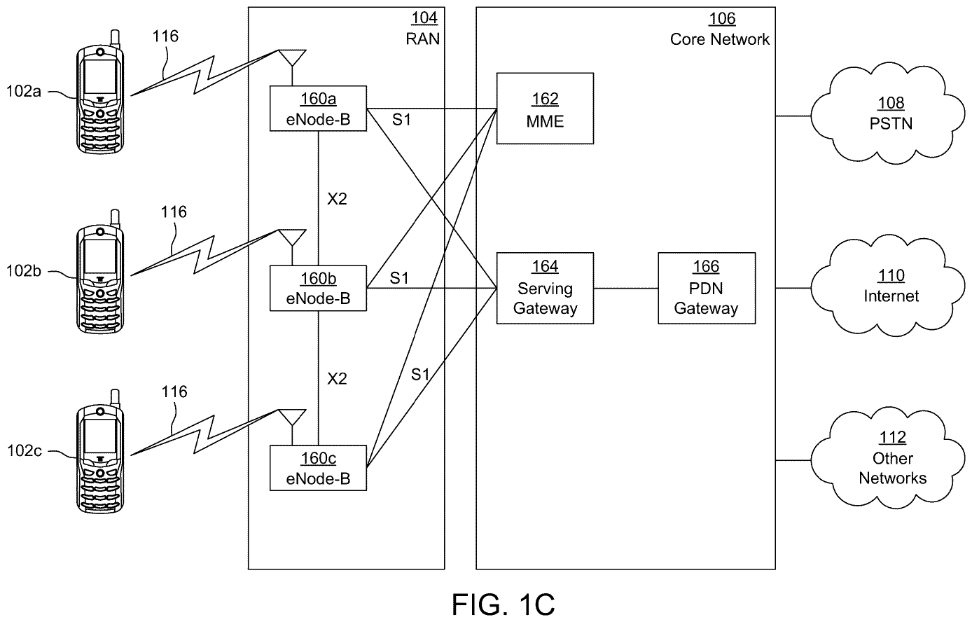

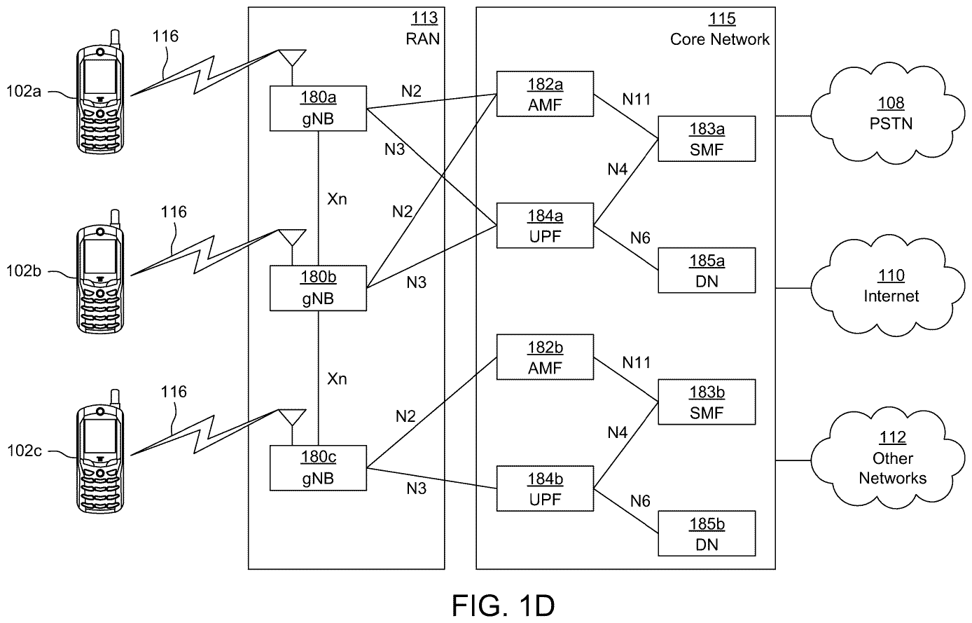

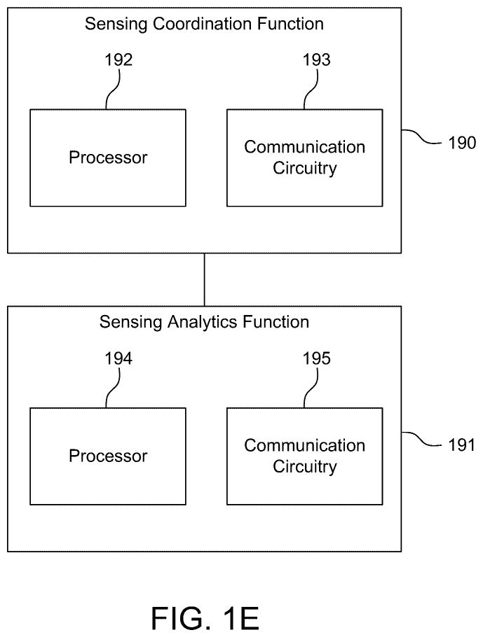

The methods, apparatuses and systems provided herein are well-suited for communications involving both wired and wireless networks. An overview of various types of wireless devices and infrastructure is provided with respect to FIGS. 1A-1E, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNB, a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more TRPs, one or more gNBs, one or more WTRUs, any network functions, one or more RANs, one or more application functions, one or more access and mobility management functions (AMFs), any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, at least one Data Network (DN) 185a, 185b, at least one sensing coordination function (SCF) 190, and at least one sensing analytics function (SAF) 191. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

FIG. 1E is a pair of illustrative block diagrams of components implementing the features of a sensing coordination function and a sensing analytics function, in accordance with certain embodiments of this disclosure. Sensing coordination function 190 and/or sensing analytics function 191 may be embedded in current or newly defined entities of a wireless network. These functions need not be defined by their execution at a particular node of a wireless network, nor based on any other networks/devices of the wireless network with which these functions interact.

Sensing coordination function (SCF) 190 includes at least processor 192 and communication circuitry 193. Sensing analytics function (SAF) 191 includes at least processor 194 and communication circuitry 195. SCF 190 and SAF 191 may be coupled to each other, as shown, or may operate independent of the other. The processors of FIG. 1E may be configured to process the contents of incoming messages (e.g., as received from a WTRU or from any component of a wireless network) and generate outgoing messages (e.g., as may be sent to a WTRU or any component of a wireless network). The communication circuitry of FIG. 1E may be configured to receive any incoming messages and transmit any outgoing messages. The respective functions shown in FIG. 1E may also include, or be coupled to, memory and any other physical components as may be needed to support the operations of the respective processors and communication circuitries.

SCF 190 coordinates the sensing operation in wireless networks. This coordination may include full or partial management of sensing sources of sensing data, other sensing data, sensing results, and sensing contextual information. Based on the collected sensing data and/or results, SAF 191 performs analytics on the sensing data, on the sensing results, or on both, and thus is capable of generating additional sensing data, sensing results, and sensing contextual information.

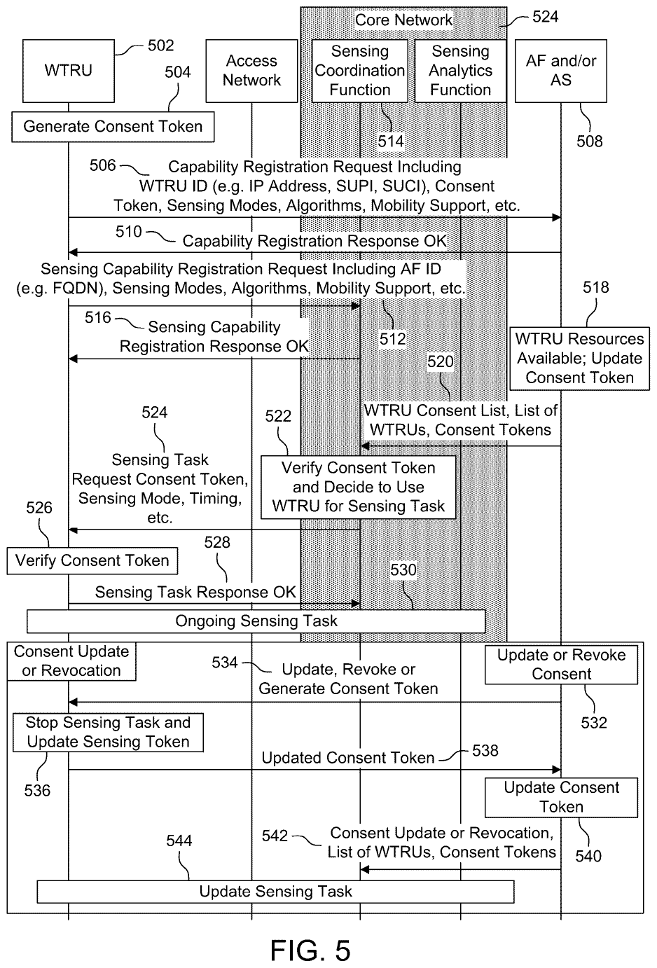

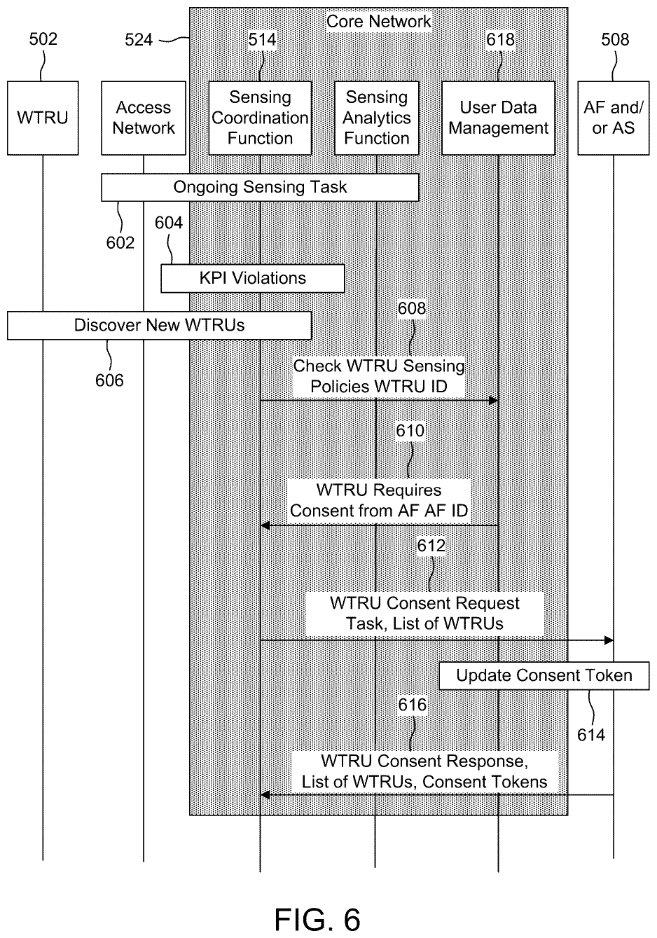

As further described below in connection with FIGS. 5-8, SCF 190 and/or SAF 191 may manage one or more consent tokens generated by one or more WTRUs. A consent token is generated by a WTRU and may be a data string that may be used to derive information related to a service or the user. For example, a consent token may specify whether a WTRU may participate in a given sensing task. The functionality and content of a consent token is further described below in connection with FIG. 6.

Furthermore, while the functions of the SCF may be incorporated into any suitable one or more other network functions; the same is true of the SAFs of FIG. 1D and FIG. 1E. In any suitable wireless system, there may or may not be specific functions dedicated to performing tasks that are ascribed herein to an SAF or an SCF.

Moreover, while SCF 190 and SAF 191 are configured for a sensing task, a wireless network may include any suitable network function configured for a network-controlled operation. For example, a wireless network may include a computing coordination function and a computing analytics function that is configured similar to SCF 190 and SAF 191, as previously described above.

In view of FIGS. 1A-1E and the corresponding description of FIGS. 1A-1E, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

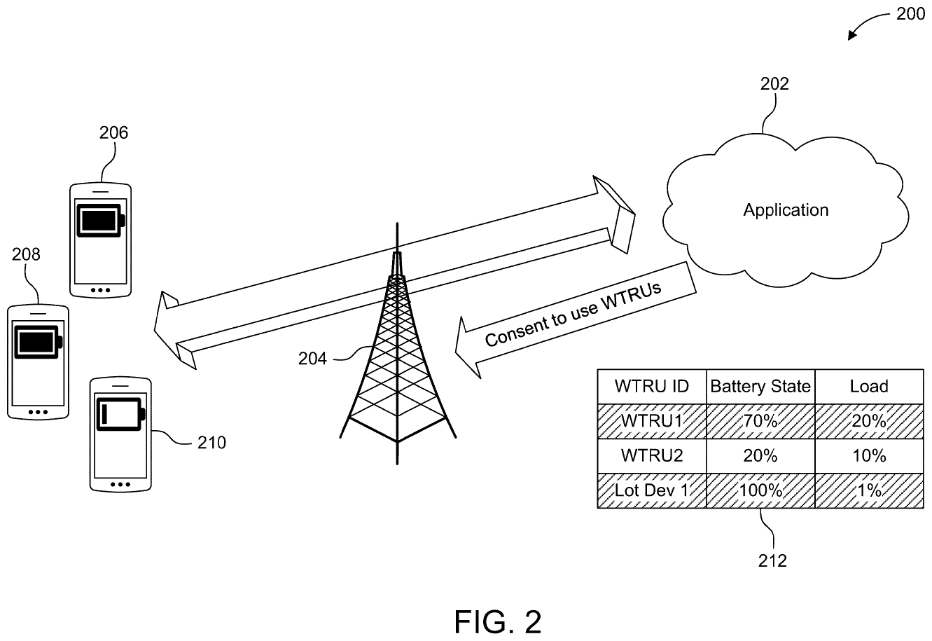

In certain embodiments of the present disclosure, including those described below at least in connection with FIGS. 2-10, the devices, systems, architectures, communication links, apparatuses, and other elements depicted in FIGS. 1A-1E may be used in connection with sensing availability evaluation of sensing entities.

Integrated Sensing and Communication (ISAC) is a feature of many wireless communication networks. ISAC improves capabilities of telecommunication networks by sensing objects in a space with only RF-based signals.

In ISAC, consent may be obtained from end-users who are authorized to provide consent on behalf of subscribers. In some approaches, there may be issues around naming of explicit reasons for why data is collected, collecting explicit consent for every use of data, and for modification or revocation of consent. As such, it may be desirable for dynamic user consent to be incorporated in a wireless network.

In some approaches, there may be issues regarding obtaining user consent for roaming and non-terrestrial networks. As such, it may be desirable for a unified framework for obtaining, coordinating, and revoking of user consent, keeping track of types of consent given to certain entities, and enforcing consent given to certain entities.

It may be desirable to implement a method that provides dynamic and unified user consent because there are several data types and tasks that a WTRU may be used for (e.g., sensing, artificial intelligence (AI), or machine learning (ML)). Such tasks may not be directly beneficial to a user, but consent for these tasks may still need to be obtained. Furthermore, sensing tasks may include the collection of personally identifying information (PII) of users such as user patterns or gestures that fall under the guidance of General Data Protection Regulation in Europe, or other regulatory bodies, so explicit consent and instructions on what can be done with collected data may be necessary to perform a task.

WTRU consent has been mainly static in the current generation of 3GPP networks. Dynamic consent is a concept that has been of interest for emerging types of services and data traffic that the 3GPP networks provide. The discourse around dynamic WTRU consent focuses on granting WTRU consent based on requests from a core network. However, there is a certain class of use-cases where consent may be provided by a service provider that owns and deploys devices or networked-entities being used for a service (e.g., sensing entities deployed by a sensing service provider or WTRUs managed by a company). Examples of these entities are internet of things (IoT) devices and reconfigurable intelligent services (RIS).

IoT devices and RIS may be deployed by application providers for their use-case while using the 3GPP network for data collection. However, IoT devices and RIS may also provide their services to the 3GPP network.

FIG. 2 is a diagram illustrating how an application may provide consent to a 3GPP network to utilize one or more WTRUs associated with the application, in accordance with certain embodiments. In diagram 200, application 202 (e.g., an IoT provider) may allow 3GPP network 204 to use any one or more of WTRUs 206-208 (e.g., which may each correspond with any one of WTRUs 102a-102d) for sensing purposes. Moreover, because an application 202 may be aware of the load and the tasks that the WTRUs are performing, it may be optimal to collect WTRU related information 212 (e.g., load, usage, or battery status) to decide whether a WTRU has sensing services that it can provide for the network. Other approaches that have looked at dynamic WTRU consent, such that consent is generated from WTRUs, have an additional overhead of communicating with the WTRUs and obtaining consent. Instead, procedures may be introduced for obtaining access information and access authorization from an application server (AS). Such procedures would reduce the additional overload on the RAN and the WTRUs.

Such a use case may be further extended such that a core network is aware of sensing being performed in a target sensing service area and is aware of IoT/RIS or other resources deployed by service providers. A core network may request consent from the service providers to use-these resources. There may be scenarios where such exchange may be performed for compensation.

It may be desirable to facilitate sharing of RAN and core network resources between mobile network operators (MNOs) and mobile virtual network operators (MVNOs). Following the principles of zero-trust architecture, when sensing as a service or computing as a service is enabled, WTRUs may be able to ensure in real-time that the request for a service originates from an entity that is authorized (e.g., either an administrator or an entity has proper access) to perform said operation in certain approaches. Such approaches extend the current notion of access, authentication, and encryption as such approaches facilitate resource sharing and real-time consent monitoring and verifications.

Data as a service is an enabler for monetization of sensing data. Such service may be further extended by networks being trusted executioners and proxies of sensing services.

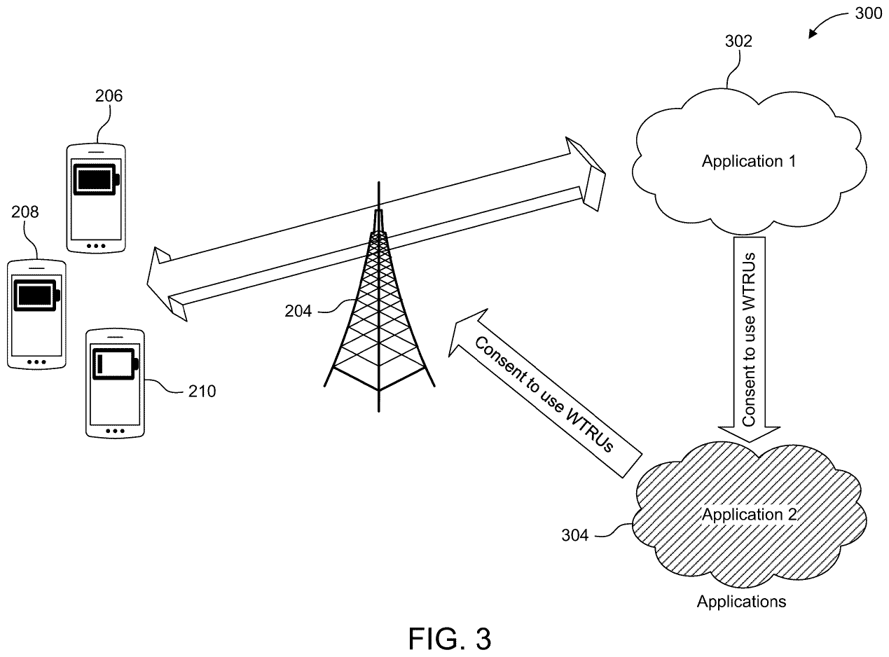

FIG. 3 is a diagram illustrating how a 3GPP network enables an application to use the WTRUs of another application, in accordance with certain embodiments. In diagram 300, second application 304 requests sensing data from WTRUs 206-210 deployed by first application 302. There may not be a service level agreement (SLA) or a trust between first application 302 and the second application 304. Instead, 3GPP network 204 may act as a trusted intermediary that may be responsible for ensuring that an SLA of the service is met (e.g., communication between first application 302 and second application 304) or ensuring the data is trusted (e.g., ensuring that the data has a certain level of quality, usability, reliability, or resiliency). In such scenarios, 3GPP network 204 may also be able to provide trustworthiness related information about first application 302 and the sensing data generated from first application's WTRUs 206-210 to second application 304 (which first application 302 may in-turn use to build its own trust information about second application 304). This may be considered as trustworthiness as a service provided by the 3GPP network.

It may be desirable to determine how a 3GPP network may obtain and enforce dynamic consent for sensing from a service provider and enable resource sharing between entities such as MVNOs and MNOs.

Dynamic consent is an aspect which provides certain functionalities as part of 6GS as new services are introduced (e.g. sensing or computing). WTRUs may be part of several different tasks managed by an application function (AF) and have limited resources. In such cases, consent for different tasks may need to be collected from the WTRU or the AF (e.g., end-user) for the WTRUs.

It will be understood that the term “consent” may refer to an explicit permission, instruction, access, or grant provided by an end-user. As previously discussed above in connection with FIG. 1E, it will be understood that a consent token may be a data string which may be used to derive information related to a service or the user (as further described below in connection with FIG. 6). A consent token is generated by a WTRU and additional metadata from an AF may act as a supplement to the consent token. There may be other information that may be associated with the consent-token that may be provided to the 3GPP system with the consent token by the AF where such information may be referred to as AF-provided metadata. For example, user-consent may be gathered from end-users and consent may be obtained from subscribers or end-users. As such, it will be understood that both end-users and subscribers may grant consent.

It will be understood that a 3GPP network may support a sensing coordination function (SCF) and a sensing analytics function (SAF). Either one or both of an SCF or SAF may be implemented as part of any other network function or may be implemented as a standalone function.

An SCF is a logical function that coordinates the sensing activities of a sensing system. An SCF may receive sensing service requests with key performance indicators (KPIs) from AFs or any suitable network function. An SCF may also be configured to retrieve or receive information about WTRUs and their capabilities. An SCF may be responsible for any one or more of scheduling sensing tasks, selecting sensing transmitters, selecting sensing receivers, or other suitable functions.

An SAF is a logical function in the 3GPP network. It may reside as an independent network function or as part of other existing network functions such as a network data analytics function (NWDAF) or SCF. An SAF may be responsible for any one or more of the following: collecting and processing sensing results, processing sensing data, checking KPI violations, or reporting the results to the sensing service requester.

An application server is a logical function that may run as part of the network, as a vertical application layer (VAL) server, as a service enabler architecture level (SEAL) application, or self-hosted by the application. The application may have access to a list of WTRUs that are deployed by or administered by itself (i.e., AF is the primary owner of the WTRUs). The list of WTRUs may be identified by an IP address, subscription permanent identifier (SUPI), subscriber concealed identifier (SUCI), international mobile subscriber identity (IMSI), or any suitable identifier that the 3GPP network can use to resolve access to a WTRU.

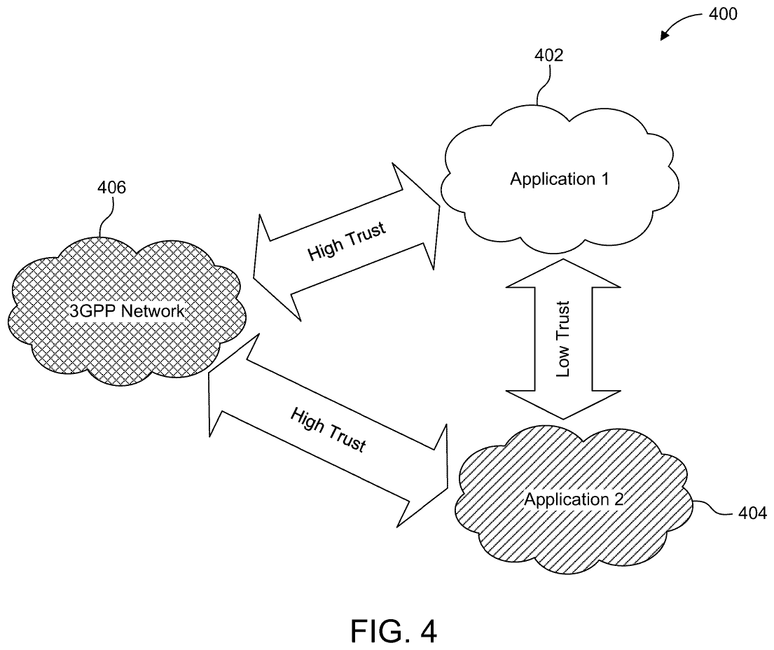

It will be understood that “trustworthiness” may refer to the ability to provide verifiable, explainable, usable, and reliable data to a service that is requesting the data. Being trustworthy involves providing evidence (e.g., in the form of metadata) to the requesting service so that a device sending data may build trust in the data being provided and with the service provider. With sensing as a use-case, there may be several parties involved in a sensing operation. An illustration of such a use-case is shown in FIG. 4.

FIG. 4 is an illustrative diagram of two applications that do not have a trustworthy relationship with respect to one another but have a trustworthy relationship with an associated 3GPP network, in accordance with certain embodiments.

In diagram 400, second application 404 (e.g., which may be the same as second application 304) is interested in using resources provided by first application 402 (e.g., which may be the same as first application 302) to use one or more WTRUs for a sensing operation. First application 402 and second application 404 have a low trust factor, for example, because both applications may not have enough evidence by way of interactions to have build a trustworthy relationship. Both first application 402 and second application 404 have enough trust built with 3GPP network 406. 3GPP network 406 (e.g., which may be the same as 3GPP network 204) may thus act as a trust-provider and QoS enforcer by executing the service on behalf of first application 402 while giving results to second application 404 and providing trustworthiness information to both applications to provide a way for first application 402 and second application 404 to build mutual trust.

In some approaches, trust (i.e., trustworthiness) is a binary concept. In other words, a WTRU, gNodeB, or application is either trusted or not trusted depending on their corresponding accepted to SLAs. However, it may be desirable for the concept of trust to no longer remain binary. Well defined trustworthiness metrics based on application, network, or vendor preferences may need to be considered to facilitate successful adoption and usage of sensing data. Trustworthiness may be a complex function and can vary depending on the use-cases. Trustworthiness levels may be defined based on the evidence that has been provided in the past interactions between applications and 3GPP networks. In this disclosure, consent tokens may be passed around applications and network functions to be used for trusted execution of tasks. Additionally, along with consent tokens, a network can also expose trustworthiness metrics about the other applications and the data being generated. For example, if an application in the past has provided trustworthy data to the 3GPP network or to another application, the 3GPP network may provide a high trustworthiness score and use this to provide services to other applications. However, if an application has provided unreliable or unusable data, the 3GPP network may inform the application requesting for such a service that the application has a low trustworthy score. The parameters that are generally considered as part of trustworthiness score may be any one or more of a quality, reliability, usability, recency, robustness, completeness, relevance, integrity, security, consistency, explainability, or accountability metric.

Accordingly, systems, methods, and apparatuses are disclosed in the present disclosure for the generation, sharing, verification, modification, and revocation of a consent token to provide a way for dynamic consent.

A WTRU that generates a consent token may be configured to register its sensing capabilities with an indication that consent is to be provided from an AF identified by AF identifying information (e.g., a fully qualified domain name (FQDN), URL, URI, endpoint, or port) and parameters subject to user consent (e.g., for an AF to initiate a sensing task using a respective WTRU). In the present disclosure, a “consent token” may also be referred to as a “WTRU-generated consent token” or simply as a “token.” In the present disclosure, “identifying information” (e.g., such as AF identifying information) may be used interchangeably with the term “identifier” or “ID.” Identifying information refers to any suitable information that may be used to identify a particular entity. In certain representative embodiments, the WTRU may receive information indicating that the WTRU may perform a network-controlled operation from a network function (NF). A network-controlled operation may refer to any one or more of a sensing, computing, data collection, artificial intelligence, or machine learning related task. It will be understood that reference to a sensing task in the present disclosure may also or instead refer to any suitable network-controlled operation. For example, in the present disclosure, reference to a sensing coordination function may instead be in reference to a machine learning coordination function, and reference to a sensing task may instead be in reference to a machine learning task. In certain representative embodiments, the WTRU may generate a consent token using a security key that it shared with one or more NFs or an AF (or application server (AS)). In certain representative embodiments, the WTRU sends a consent token to an AF; the WTRU may receive a network-controlled operation request associated with the consent token and may the request may include the same WTRU-generated consent token; the WTRU may verify that the consent token is authentic and that integrity of the consent token is maintained based on any one or more of message authentication codes, keys, or counters indicating the number of times a consent token has been used; and the WTRU may receive a request to update or revoke the consent token, and the WTRU may send the updated or revoked consent token to an AF.

A network function (NF), such as a sensing coordination function, computing coordination function, or any suitable network function having suitable hardware and/or software configured to coordinate a network-controlled operation, may receive a capability registration request (e.g., a sensing capability request). Such an NF may be part of a core network. In certain representative embodiments, such a message includes an indication that consent is to be provided by an AF identified by AF identifying information and parameters subject to user. In certain representative embodiments, the NF sends a sensing capability registration response a WTRU. In certain representative embodiments, the NF receives a message with an updated WTRU consent list from an AF (e.g., via a network exposure function (NEF)) with a list of WTRUs and consent tokens including WTRU-generated user consent tokens and/or AF-provided metadata. In certain representative embodiments, the NF verifies that the content of the consent token is authentic, and integrity maintained based on message authentication codes by fetching addresses of NFs where appropriate keys are available, and communicating with said NFs to perform authentication and integrity checks. In certain representative embodiments, the NF determines whether to use a consent token corresponding to a respective WTRU for a task and initiates a task request with consent tokens or a reference of the token as part of the service request to the respective WTRU. In certain representative embodiments, the NF will receive an acceptance message or a rejection message from a WTRU to perform a task. In certain representative embodiments, the NF receives an instruction to modify or update a currently used consent token from an AF with an updated consent token, WTRU identifying information, or an update for an ongoing task based on an updated content token. In certain representative embodiments, the NF sends a WTRU consent request to an AF with a list of one or more tasks and WTRUs; the NF may receive a WTRU consent response from the AF with the list of one or more tasks and WTRUs; and the NF may send an instruction to perform a consent token validity check to an AF (e.g., when a consent token nears expiry with a list of consent token identifying information and WTRUs).

Further detail of how a WTRU that generates a consent token and how a network function configured to coordinate a network-controlled operation participate in a task with dynamic consent is described below.

In certain representative embodiments, consent management may be performed by a function of an end-user (e.g., via an AF) instead of a WTRU (e.g., as implemented in other approaches). Consent being generated by one or more AFs may be more efficient than requesting consent from individual WTRUs for at least one of the following reasons: gathering consent from WTRUs for every task may incur additional communication overhead; WTRUs may have different availabilities based on the tasks they are performing, and it may be more optimal for AF monitoring functions of WTRUs to decide whether the WTRUs should participate; and if WTRUs update their consent based on the request from AF, the WTRUs may incur an unnecessary communication overhead and the request may not be useful as there may not be a task that requires resources that the WTRU is offering.

FIG. 5 is a diagram illustrating a procedure for user-consent collection initiated by an AF, in accordance with certain embodiments. In diagram 500, WTRU 502 (e.g., which may correspond to any of WTRUs 102a-102d or 206-210), may be pre-configured to communicate with any suitable AF when WTRU 502 turns on.

At 504, WTRU 502 (e.g., on boot) generates a consent token. A consent token may be a time-based token that WTRU 502 generates based on its corresponding one or more AF policies for access to its resources. This token may be generated because of obtained consent from a user or because of a local configuration. One or many tokens may be generated by WTRU 502 for different purposes (e.g. sensing, computing, data collection). A token may be signed using a hash function. A token may be shared between the AF, WTRUs, or network. A token may be in JavaScript object notation (JSON) web token format. Any suitable technique may be used to generate a token that can be passed around the system to ensure that the calling functions have the permissions to use these resources.

At 506, WTRU 502 registers with AF/AS 508 with a capability registration request. The capability registration request includes all the parameters that AF/AS 508 may determine to be relevant such as any one or more of a WTRU identifier (e.g. SUPI, SUCI, or general public subscription identifier (GPSI)), WTRU-generated user consent tokens, sensing modes, sensing algorithms, mobility support, location, or computing capabilities.

At 510, AF/AS 508 stores information from 506 in its local database and sends a capability registration response to WTRU 502.

At 512, WTRU 502 initiates a sensing capability registration request with SCF 514 (e.g., which may be implemented as part of a UDM or may correspond to SCF 190) for its sensing or computing resources. The request includes task capabilities of WTRU 502 such as supported sensing capabilities, sensing modes, supported runnable algorithms, and a consent request field with parameters that AF/AS 508 may update along with an AF/AS identifier as a point of contact in case consent is needed.

At 516, SCF 514 stores information related to the sensing capability registration request from 512 (e.g., in a UDM/UDR) and acknowledges the request with a sensing registration response (e.g., to WTRU 502). It will be understood that 506 and 510 may occur after 512 and 516. In other words, the order of operations 506, 510, 512, and 516 may occur in any suitable order.

At 518, AF/AS 508 determines that WTRU resources may be shared with a 3GPP system (e.g., AF/AS 508 may estimate that there may be some available WTRU resources for a time period). AF/AS 508 may gather this information through any one or more of the following ways: periodically monitoring availability information (e.g., location, central processing unit (CPU) or graphics processing unit (GPU) usage, or battery state) of WTRUs; querying WTRUs for performance state information; or checking tasks scheduled for WTRUs. Once AF/AS 508 has determined a suitable WTRU list, AF/AS 508 may append to the WTRU-generated user consent token with metadata parameters that may be controlled by AF/AS 508 (e.g., expiration time or pricing).

At 520, AF/AS 508 sends a WTRU consent list update to an NF. The NF may be SCF 514, a UDM, or any suitable NF responsible for handling consent for WTRUs. The WTRU consent list update may include any one or more of a list of WTRUs, WTRU-generated user consent tokens, or AF-provided metadata. Time duration may additionally be provided or be part of the AF-provided metadata because consent may be revoked or updated at any point by AF/AS 508 depending on the change of its circumstances.

At 522, SCF 514 receives an updated WTRU consent list (e.g., as described in 520). SCF 514, at any suitable point in time, may determine to use the WTRUs from the WTRU consent list for a task (e.g. sensing or computing). The determination may be based on any one or more of location of the WTRUs, charging or incentive mechanisms, capabilities, or timing parameters. Additionally, core network 524 (e.g., which may be the same as core network 106 or 115) may also verify the token before accepting the token.

At 524, SCF 514 initiates a sensing service task request with selected WTRUs once it has chosen to use said WTRUs for sensing. The request may include parameters such as any one or more of a sensing mode, operational duration, processing performance, or the consent token for the WTRU. The request may include the consent token in whole, in-part, or a reference to the consent token. For example, the entire content of the consent token may be included as part of the request. In another example, an identifier of the consent token, such as a name or ID of a consent token, may be included in the request. Additionally, the consent token may contain a field called a service correlation identifier. Such a field may bind a consent token explicitly with a sensing service task. In certain representative embodiments, an NF of core network 524 may add such a field.

At 526, WTRU 502 performs a verification of the consent token locally. WTRU 502 may checks whether the token is still valid and is the correct token for the type of service requested. In certain representative embodiments, consent information (e.g., via a token) may be presented to the user (i.e., subscriber) for obtaining user's (i.e., subscriber's) verification information.

At 528, if the token is valid, a sensing service task response is sent with an acceptance message (e.g., an “OK” message), and WTRU 502 joins the sensing group. If the token is invalid, the WTRU 502 rejects the token and may respond to SCF 514 with a failure code if a policy from AF/AS 508 specifies to do so. WTRU 502 may not respond to SCF 514 if WTRU 502 is in a power-saving mode.

At 530, if WTRU 502 accepts such token, then WTRU 502 is part of the sensing task and performs actions relevant with respect to the sensing task.

Modification or revocation of consent may occur regardless of whether WTRU 502 is part of an active sensing task or not. AF/AS 508 may update or revoke consent dynamically and at any given point.

At 532, a consent update or revocation is triggered by AF/AS 508. An update or revocation may be triggered if AF/AS 508 requirements change or if WTRU availability changes (e.g., based on CPU or GPU usage, battery level, or location).

At 534, AF/AS 508 sends a request to WTRU 502 to update, revoke or generate a new consent token based on a desired action.

At 536, WTRU 502 updates its consent token and stops any tasks currently being executed. In certain representative embodiments, WTRU 502 may also inform SCF 514 about the choice to stop participating in the task before it stops the task depending on the policy AF/AS 508 has set for the particular WTRU. In certain representative embodiments, updated consent information (e.g., via token) may be presented to a user of WTRU 502 for obtaining user's verification.

At 538, WTRU 502 sends to AF/AS 508 the updated token list with corresponding AF/ASs to be used for future tasks.

At 540, AF/AS 508 updates one or more WTRU-generated user consent tokens with AF-provided metadata parameters that may be updated.

At 542, AF/AS 508 sends an updated consent list with the list of corresponding WTRUs and new consent tokens to SCF 514.

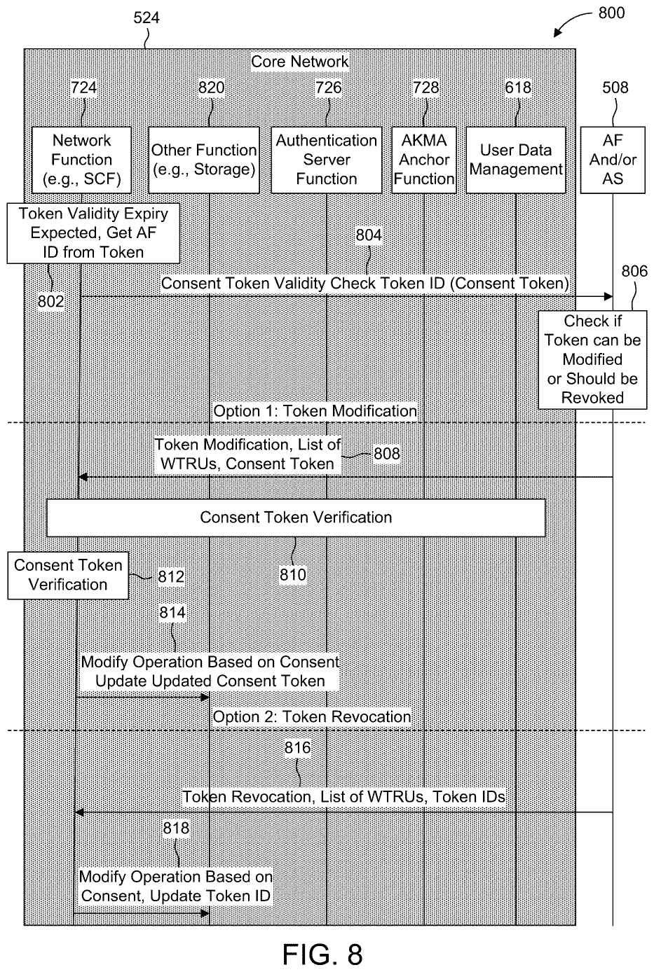

At 544, SCF 514 updates the sensing task based on the consent update which may involve re-selecting WTRUs, updating the location of processing, or any other task an SCF had designated the WTRU to perform (as further described below in connection with FIG. 8).

Based on the operations discussed in connection with FIG. 5, dynamic consent may be taken from AFs for tasks involving AF-deployed WTRUs. Diagram 500 corresponds to a sensing related task but can be generalized to any other task (e.g. computing or data collection) where user consent needs to be obtained by AF involvement.

In certain representative embodiments, one or more network functions of a core network may request consent for certain WTRUs to perform a task from an application function.

FIG. 6 is a diagram illustrating a procedure where a network function of a core network sends a request to an AF to use one or more WTRUs for some network-controlled operation, in accordance with certain embodiments.

In certain representative embodiments, when a WTRU registers its capabilities (e.g., for sensing, computing, or any other resource usage) with a UDM/SCF, the WTRU may indicate to the network that any consent for using its resources may be determined from an associated AF (e.g., indicated by an FQDN or IP address).

At 602, a sensing task (or any suitable network-controlled operation) may be ongoing such that WTRU 502, which is administered or otherwise associated with AF/AS 508, is not being used in a sensing task.

At 604, SCF 514 determines that sensing capabilities from a third-party sensing service are to be used. Such a determination may be based on any one or more of the following: a KPI violation occurring possibly due to a function of any one or more of a sensing target moving, WTRUs moving out of a sensing coverage area, sensing reference signals not being received, or availability of WTRUs changing (e.g., due to low battery or compute ability); charging or incentivization policies such as in situations where it may be cheaper for an SCF to use AF-managed WTRUs for sensing instead of WTRUs associated with a core network (e.g., because incentives for sensing may vary on use-cases and location); or a lack of available WTRUs such as a case where a sensing task may be on going in locations where the number of WTRUs or gNBs needed for sensing may not be sufficient to meet certain KPIs.

At 606, SCF 514 initiates discovery of new WTRUs that may be used for sensing. Discovery may also be performed after 608-616 are performed to reduce the overhead on the RAN and the WTRUs. The decision of whether to verify consent before or after discovery may vary across certain implementations.

At 608, SCF 514 may generate a list of WTRUs that may be suitable for performing a sensing task and check each respective policy from the list of WTRUs with UDM 618.

At 610, UDM 618 responds to SCF 514 with a message that the chosen one or more WTRUs require consent from an AF and an identifier to contact the AF (e.g. FQDN or IP address).

At 612, SCF 514 initiates a WTRU consent request to AF 508. The request indicates the task (e.g., sensing or computing) and the list of WTRUs that SCF 514 is requesting consent for. As part of the WTRU consent request, SCF 514 may include any one or more of information related to a compensation or incentivization scheme, how long SCF 514 is to use the one or more WTRUs for, a location of operation, or any suitable parameter that AF/AS 508 may use to decide whether or not to provide consent.

At 614, AF/AS 508 selects the WTRU-generated user consent token based on what AF/AS 508 determines that core network 524 may use a corresponding WTRU for. AF/AS 508 appends AF-provided metadata to the WTRU-generated user consent token. The determination of whether to allow core network 524 to use the WTRUs may depend on the availability of the WTRUs (e.g., based on CPU or GPU usage, battery state, location, or current load) or a specified compensation and incentivization mechanism.

At 616, AF/AS 508 may determine that SCF 514 may utilize certain WTRUs and send a list of relevant WTRUs (including one or more WTRUs) and corresponding consent tokens (including one or more consent tokens) to SCF 514. Once SCF 514 receives said message from AF/AS 508, procedures described in connection with 524 of FIG. 5 may be applicable, and SCF 514 may send a sensing task request with a corresponding consent token to a suitable WTRU.

A consent token may include any one or more of the following fields: task information, task specifications, target sensing service area related information, time related information, pricing related information, data type expectations, overhead related information, data storage or sharing related information, message authentication codes, an AF identifier, a public land mobile network (PLMN) identifier, a WTRU identifier, or a service correlation identifier. Task information may specify the type of task that a WTRU may perform (e.g., sensing, computing, machine learning, or positioning).

Task specification information may indicate whether a WTRU may perform monostatic sensing, bistatic sensing, transmission related tasks, or receiving related tasks. Time related information may indicate a valid duration, maximum amount of time, or expiration time for a network-controlled operation (or any suitable task). Pricing related information may indicate a minimum unit of incentive. Data type expectations may specify whether only channel state information (CSI), radar cross section (RCS), or micro-doppler data may be provided. Overhead related information may specify a maximum amount of computation or communication bandwidth that may be used for a task. Data storage or sharing related information may specify any one or more of explicit purposes data may be used for, a maximum time data may be stored for, a data storage location, entities that may trigger data collection, or entities that may use stored data.

Message authentication codes may refer to how a WTRU may additionally appends a message authentication code for a WTRU-generated user consent token. The keys used for this message authentication code may be the keys shared between core network 524 and a WTRU (e.g., via a key authentication server function (KAUSF)) which allow core network 524 to verify the WTRU consented parameters when it receives the token from AF/AS 508.

An AF identifier may be an FQDN, URL, URI, or port. The AF that shared the consent token may need to have an identifier such that core network 524 may keep track of which AFs are granting consent. When provided by WTRU 502, core network 524 may verify that the AF that requested an operation matches the AF that a user granted consent to initiate the operation to. A list of one or more AF identifiers may be used to differentiate functionality. For example, one AF identifier may correspond to an AF that be grants consent for WTRUs while another AF identifier may correspond to an AF that is a data consumer or service caller. As such, an AF identifier may be a list with additional information regarding the parts of the request the addresses are useful for. An AF identifier may also be used by core network 524 obtain consent or check validity of the consent token from the AF represented by the AF identifier.

A PLMN identifier may indicate networks (e.g., home or visited networks) that a given consent token is valid for. A WTRU identifier may be a SUCI, may be provided by a WTRU, and may be used by core network 524 to verify that the WTRU that the AF is requesting to use for a task matches the WTRU which a user has granted consent to perform said task.

A service correlation identifier may be provided by a WTRU or AF for a specific service request that consent is being granted for. For example, if there is an already existing sensing service request that has been initiated with core network 524, and an AF wants to provide additional WTRUs for the task, a service correlation identifier may be added as part of the consent token such that core network 524 has access to information indicating that certain WTRUs may be used for one or more certain tasks.

In certain representative embodiments, a content token may only include information from when the consent token was initially generated (e.g., at WTRU 502). In such embodiments, WTRU 502 and AF/AS 508 do not share keys, and AF/AS 508 has no control over content that may appear with or otherwise supplement the consent token. AF/AS 508 may only forward the consent token to core network 524 when it determines that resources are available (e.g., as previously described above in 518 from FIG. 5).

In certain representative embodiments, AF/AS 508 may provide additional metadata (e.g., to core network 524) with the information provided by a consent token). In such embodiments, WTRU 502 and AF/AS 508 may share a key (e.g., derived using an authentication and key management for applications (AKMA) anchor function (AAnF)). Such a key may be generated using any functionality provided by a 3GPP network (e.g., an AKMA) or by out-of-band generation. In other words, WTRU 502 may generate consent token parameters based on, for example, its capabilities or location, and AF/AS 508 may add other metadata such as time-related, pricing, data storage and sharing related information.

In certain representative embodiments, when AF/AS 508 is involved in providing metadata, core network 514 (which may enable generation of a message authentication code) may verify the consent parameters generated from WTRU 502. However, if core network 524 wants to verify the consent-generated parameters from AF/AS 508, there are two parameters that may be used. First, as previously described in 512, during the registration process, WTRU 502 may send list of AF-permitted consent parameters. Such a list enables WTRU 502 to inform core network 524 that certain parameters will be generated by an AF. Second, WTRU 502 and AF/AS 508 may share a key stored in the AAnF that may be used to verify the AF-provided metadata.

In certain representative embodiments, a consent token may additionally be protected for replay protection by configuring the token to be single use, to have a short validity duration, or to have a nonce or counter used as part of token generation.

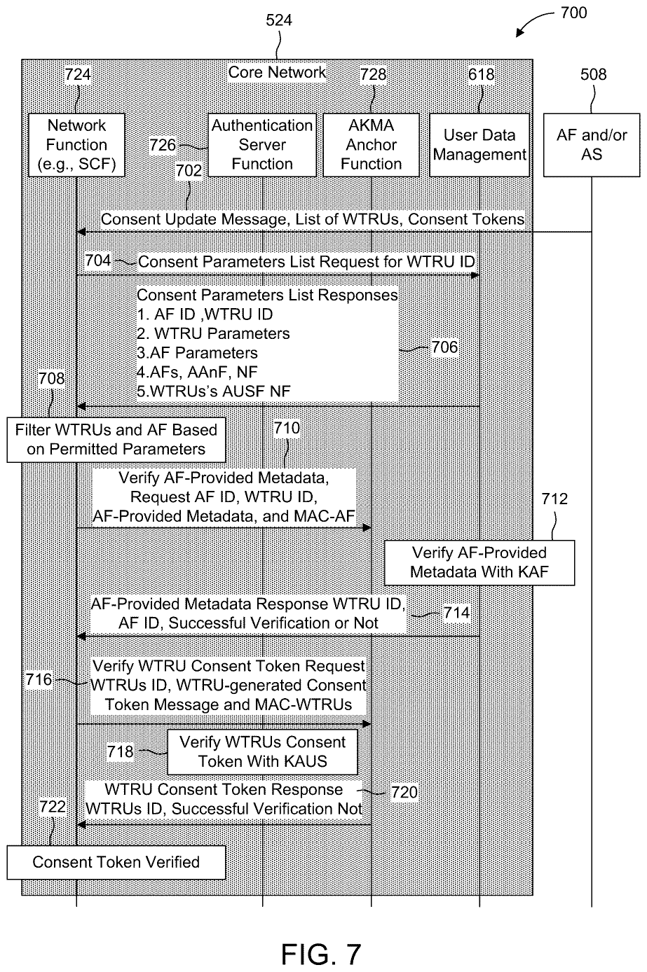

FIG. 7 is a diagram illustrating a procedure where a network function verifies the authenticity and integrity of a consent token, in accordance with certain embodiments.

In diagram 700, it will be understood that a WTRU (e.g., WTRU 502) has sent to an AF (e.g., AF/AS 508) a consent token. The AF will then request to a core network (e.g., core network 524) to initiate a sensing operation (or any suitable network-controlled operation) using a respective WTRU.

At 702, AF/AS 508 sends a request to perform sensing operations using one or more WTRUs. The request includes a consent token list sent to NF 724 (e.g., which may be the same as SCF 514 or any suitable network function) that can verify the authenticity of the token. The consent token list may include identifiers for WTRU(s) and protected consent token(s). A consent token may include one or more consent parameters and one or more message authentication codes (e.g., as previously described above in connection with FIG. 6). NF 724 performs verification of the consent token with assistance of a consent verification function such as authentication server function (AUSF) 726, AAnF 728, or any suitable consent dedicated function. For example, WTRU-generated user consent parameters may be signed with a network shared key (e.g., via a KAUSF) and verified using AUSF 726 assistance. In another example, the consent token may be protected using a shared key between the WTRU and the AF and verified using AAnF 728 assistance. In yet another example, AF-provided metadata may be protected in an AF-WTRU shared key.

At 704, NF 724 requests from UDM 618 a consent parameters list based on a WTRU identifier. AF/AS 508 may provide WTRU identifying information (e.g., GPSI) in the request to NF 724. AF/AS 508 may provide such information directly to NF 724 or via an NEF. NF 724 may locate the serving AUSF or AAnF based on information (e.g., GPSI or SUCI) from the consent token. If a SUCI is specified, then UDM 618 (e.g., via a subscriber identity de-concealing function (SIDF)) de-conceals SUCI into SUPI.

At 706, UDM 618 responds to NF 724 with any one or more of a WTRU identifier, parameters that the WTRU provides user consent and/or control for, or parameters that the AF can control (e.g. pricing or timing). UDM 618 may provide addressing information (e.g., address, NF identifier) of the NF that can perform the verification of the consent token from the WTRU or AF generated metadata (e.g., AUSF or AAnF).

At 708, NF 724 verifies that AF/AS 508 is authorized for the sensing request. For example, NF 724 may verify that a WTRU provided consent token is provided if the task is subject to user consent. In another example, if a WTRU consent token is expected for the requested task type, and if AF/AS 508 does not provide a consent token, then NF 724 may reject the request from AF/AS 508.

At 710, in certain representative embodiments, NF 724 requests verification of the protected consent token and metadata from AF/AS 508 by an AAnF 728. NF 724 may provide AAnF 724 with any one or more of: an AF identifier, a WTRU identifier, or protected consent token along with the message authentication code.

At 712, AAnF 728 verifies the AF-provided metadata with any one or more of the shared keys between a WTRU and AF/AS 508 or the contents of the metadata. An example of verification process is illustrated in 718.

At 714, AAnF 728 responds with the AF identifying information, WTRU identifying information, and whether the consent token can be verified.

At 716, in certain representative embodiments, NF 724 requests from AUSF 726 to verify the contents of the WTRU-generated user generated consent token with WTRU identifying information, the consent token, and the message authentication code.

At 718, AUSF 726 verifies the WTRU-generated user consent token based on the shared secret keys between the core network 524 and the WTRU (e.g., via KAUSF). AUSF 724 generates an expected message authentication code using the consent token, the KAUSF, and a consent counter. AUSF 724 compares the generated expected message authentication code with the message authentication code received with the consent token. AUSF 724 determines whether the consent token is valid based on the matching of the two message authentication codes.

At 720, AUSF 726 responds to requesting NF 724, indicating whether the token was successfully verified.

At 722, if the WTRU-generated user consent token and the AF-provided metadata are successfully verified (e.g., the consent token is considered successfully verified and that the operations requested by the AF are compatible with the consent token), NF 724 (e.g., an SCF) may proceed with initiating the operations requested by AF 724. A consent token may also be shared in anticipation of a future network-controlled operation. The request for a future service request may be from the same AF (e.g., AF/AS 508), another NF, or another AF.

Additional protection against replay attacks, such that the consent token is used more than an appropriate number of times, may be provided by a counter shared between a WTRU and the core network (e.g., provided by AUSF 726 or AAnF 728). A counter may be used as input for message authentication codes for both a WTRU or AF. Whenever a new consent token is generated by the WTRU to be shared with an AF, the WTRU may locally increment this counter. Similarly, the counter may be incremented by the core network when initially processing a consent token or when processing a modified or revoked consent token. A WTRU, AUSF 726, or AAnF 728 may set the consent counter to a chosen value (e.g., zero) when a new KAUSF or KAF is generated (e.g., following a primary authentication). Additionally, the consent tokens may have limited time validity to reduce the effect of the consent token being used for a replay attack.

FIG. 8 is a diagram illustrating a procedure for revoking or updating a currently used consent token, in accordance with certain embodiments.

As previously discussed above in connection with 532-544 of FIG. 5, a consent token maybe updated or revoked when an AF (e.g., AF/AS 508) determines that consent needs to be updated. Consent may need to be updated according to a determination made by an AF locally or based on a determination made by the WTRU associated with the consent token. In certain representative embodiments, the time that a consent token is valid for may expire, and the core network using the WTRU may need to verify whether a new consent token is to be issued or whether the duration which the consent token is valid for may be extended. Operations related to modification and revocation of consent token are described further below in connection with diagram 800.

At 802, NF 724 obtains a consent token and determines that it is to check the validity of the obtained consent token. For example, NF 724 may determine that the consent token is nearing expiry. In another example, the consent token may include validity check requirements that indicate to NF 724 a schedule at which the validity check should be performed. NF 724 may obtain AF identifying information (e.g., FQDN, URL, URI, endpoint, port) and validity check requirements from the consent token.

At 804, NF 724 initiates a consent token validity check message with AF/AS 508 and sends a token validity check message to AF/AS 508. The message may include any one or more of token identifying information, the consent token itself, or information identifying NF 724.

NF 724 may be required to check for consent token validity based on a validity check schedule to prevent unexpected or unwanted consent token expiration. In other words, AF/AS 508, which manages the consent token, may determine to invalidate a consent token if NF 724 does not perform a validity check based on the validity check schedule indicated in the consent token.

At 806, AF/AS 508 determines whether the consent token is valid, has been invalidated, or revoked. For example, a consent token may have expired based on the validity check schedule, a consent token may become invalid due to a WTRU moving to a different area (e.g., AF may obtain the WTRU or user location from the network), or a WTRU may have explicitly revoked the validity of the consent token by determining that a corresponding user does not want to participate in the activity consented to.

While not explicitly illustrated in diagram 800, if a consent token is determined to be invalid, AF/AS 508 may send a response message in accordance with the message received in 804. The message may contain an indication of the consent token validity and an identifier of the consent token for which the validity indication is provided. Upon receiving the response message, NF 724 may determine whether the token is still valid before allowing processing associated with the consent token. If a consent token is invalidated by the response message, the requesting NF may stop any processing associated with the token and may delete the token.

In one option, the consent token may be modified. At 808, if AF/AS 508 or a respective WTRU (e.g., WTRU 502) determines that the token may be modified, a new token is generated with updated parameters such as expiry time. This updated token is then sent as a token modification request to NF 724. The token modification request may contain the list of WTRUs for which the consent is being updated and the new consent token. In certain representative embodiments, the response may also contain identifying information of the currently used consent token which allows NF 724 to compare the updated parameters and only take actions based on what has changed. For example, if only expiry time has been updated, NF 724 may only need to update other network functions 820 (e.g., storage functions) such that there is a new expiry time for a particular consent token identifier.

At 810, NF 724 verifies the newly generated consent token (e.g., as previously discussed above in connection with FIG. 7).

At 812, once the newly generated consent token has been verified, NF 724 determines which one or more functions of the ongoing task are to be modified based on the contents of the token. NF 724 may compare the difference of the currently used consent token with the newly generated consent token, or NF 724 may update the entire ongoing task based on the parameters of the newly generated consent token.

At 814, NF 724 modifies operations based on the newly generated consent token. For example, other network functions 820 may be modified or informed of the updated parameters of an ongoing task.

In a second option, a consent token may be revoked. At 816, if AF/AS 508 determines (e.g., based on communication with a WTRU, a location update, an availability change, or incentivization changes) that a consent token needs to be revoked, AF/AS 508 sends a token revocation message with the list of WTRU identifying information and consent token identifying information for which the consent was revoked. AF/AS 508 may specify a field indicating that whether revocation should occur immediately or where revocation is based on an expiry time.

At 818, NF 724 may modify operations based on the consent token being revoked and may transmit consent token identifying information to other functions 820.

In certain representative embodiments, 802-806 may be repeated according to a validity check schedule and validation endpoint included in a consent token.

In certain representative embodiments, a validity check schedule and validation endpoint may be provided separately from the consent token. For example, a validity check schedule and validation endpoint may be provided as separate information when the consent token is provisioned in a NF.

In certain representative embodiments, validity check schedule may be based may be based on other contextual information such as a location. For example, a validity check may be required when a location change occurs.

In certain representative embodiments, validity check interactions described in 802-806 may be logged in a ledger by AF/AS 508 and/or NF 724. Such logs may be used to establish user consent traceability. User consent traceability allow the establishment if a timeline of activity (e.g., data access) by AF/AS 508 and/or NF 724 in accordance with the consent token usage. A timeline of activity may specify what user data was accessed. User consent traceability may be a regulatory requirement in certain jurisdictions.

In certain representative embodiments, (e.g., for auditing or compliance purposes) it may be desirable to keep track of which entities used a consent token and subsequent actions performed based on the consent token. A traceability ledger may be stored in various network functions, an NEF configured to store for token based interactions happening with an AF, or UDM configured to store interactions that involve NFs fetching consent parameters.

In certain representative embodiments, a single network function (e.g., a network function configured to track user consent information, or a network function configured to track traceability information) may be responsible for tracking consent token related interactions. For example, consent tokens may be given to said network function, and said network function may inform other network functions that a consent token associated with a particular WTRU is available and can be obtained if needed.

In certain representative embodiments, every time a network function consumes a consent token, the network function may store in itself or in another network function any one or more of a log of the start and stop times of when it used the consent token, token identifying information, its own network function identifying information, or usage parameters (e.g., if consent was given for sensing and computing tasks, then the NF would store whether it used the consent token for one or both types of tasks). Consent tokens may also be stored by an NF or a central data store (e.g., a UDR) to allow traceability for which consent tokens were utilized for what purposes. If a consent token was not used by the network for any purpose and the consent token lapsed or was revoked, the network may choose to delete information related to the consent token.

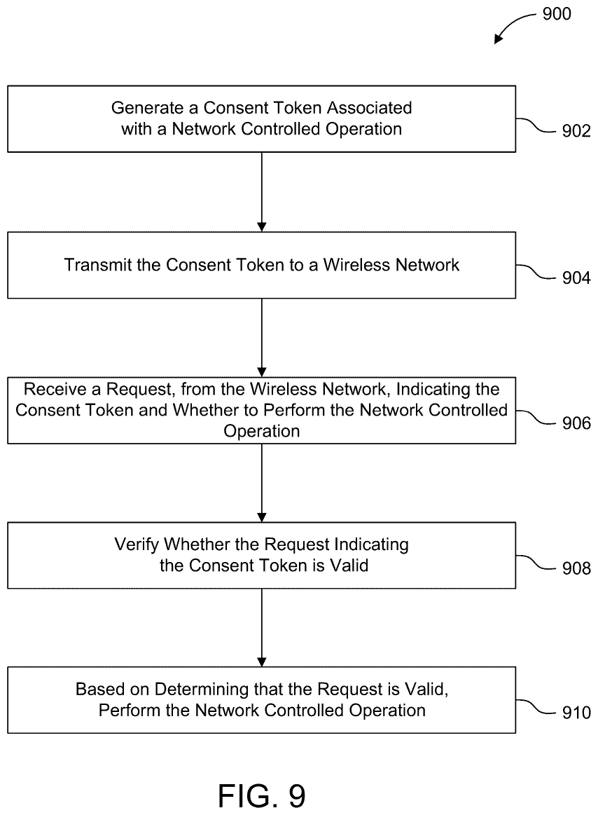

FIG. 9 is a flowchart of an illustrative method performed by a WTRU for performing a network-controlled operation based on a consent token, in accordance with certain embodiments. Such a method is illustrated as method 900 and includes at least operations 902-910.

At 902, a WTRU (e.g., any one of WTRUs 102a-102d, 206-210, or 502) generates a consent token associated with a network-controlled operation. In certain representative embodiments, the network-controlled operation is related to any one or more of sensing, computing, data collection, artificial intelligence, or machine learning. In certain representative embodiments, the consent token includes a digital signature generated by a hash function. In certain representative embodiments, 902 may correspond to 504 of FIG. 5.

At 904, the WTRU transmits the consent token to a wireless network. In certain representative embodiments, 904 may correspond to 506 of FIG. 5.

At 906, the WTRU receives a request, from the wireless network, indicating the consent token and whether to perform the network-controlled operation. In certain representative embodiments, the consent token may be fully included in the request (i.e., the entire contents of a consent token may be included in the request). In certain representative embodiments, the request may indicate the consent token by referencing some aspect of the consent token (e.g., a name of the consent token or by service correlation information). In certain representative embodiments, the request further indicates metadata provided by a network entity (e.g., an application function or a network function of a core network). In certain representative embodiments, the consent token or the metadata provided the network function may indicate any one or more of the following: information of a type of network-controlled operation that the consent token is associated with; configuration information associated with the WTRU; target sensing service area related information; time validity related information; pricing related information; acceptable data type information; bandwidth availability information; data storage configuration information; data sharing configuration information; a message authentication code such that the message authentication code is shared between the WTRU and the wireless network to verify at least one of authenticity or integrity of the consent token; application function identifying information; information specifying one or more networks the consent token is valid for; WTRU identification information; or service correlation identifying information such that the service correlation identifying information indicates one or more ongoing or previous network-controlled operations that the WTRU is suitable for. In certain representative embodiments, a message authentication code is verified by a shared key shared between the WTRU and a network entity where the shared key is used to generate the message authentication code (e.g., as previously discussed above in connection with FIG. 7). In certain representative embodiments, 906 may correspond to 524 of FIG. 5.

At 908, the WTRU verifies whether the request indicating the consent token is valid. In certain representative embodiments, verifying whether the request indicating the consent token is valid includes verifying any one or more of: reference information indicated in the request; whether the consent token was received from a correct application function; whether the consent token indicates correct PLMN identification information; time information associated with the consent token; whether the consent token is properly associated with the request; authenticity of the consent token; integrity of content of the consent token; or whether the consent token is associated with the WTRU. In certain representative embodiments, 908 may correspond to 526 of FIG. 5.

At 910, based on determining that the request is valid, the WTRU performs the network-controlled operation. In certain representative embodiments, 910 may correspond to 530 of FIG. 5.

In certain representative embodiments, method 900 further includes receiving a second request from the wireless network to revoke validity of the consent token (e.g., which may correspond with 532-534 of FIG. 5). Based on receiving the second request, the WTRU verifies the second request, updates the consent token, and halts performance of the network-controlled operation. In certain representative embodiments, the WTRU further informs the wireless network that the WTRU will stop performing the network-controlled operation based on receiving the second request.

In certain representative embodiments, method 900 further includes the WTRU receiving a second request from the wireless network to update the consent token, verifying the second request, and updating the consent token based on the second request (e.g., which may correspond with 532-544 of FIG. 5).

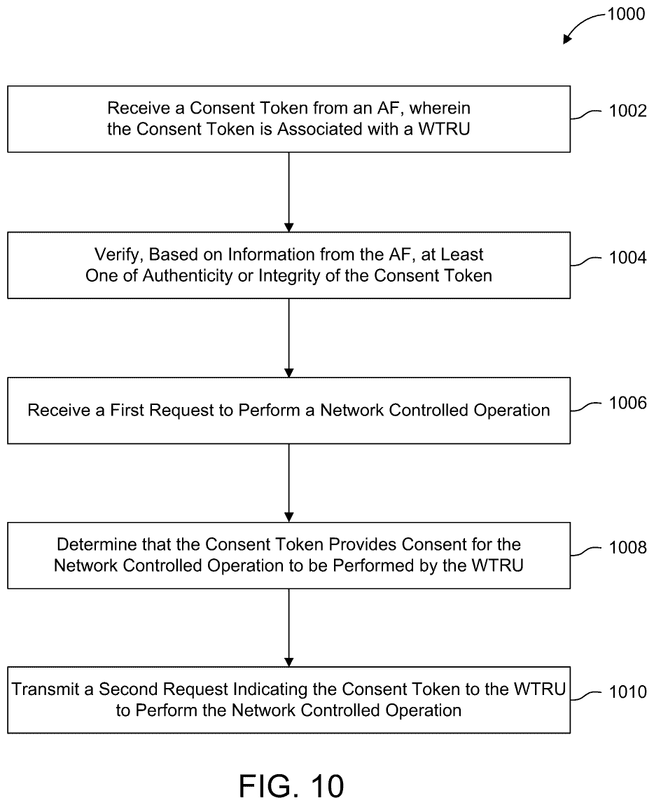

FIG. 10 is a flowchart of an illustrative method performed by a wireless network entity for coordinating a network-controlled operation based on a consent token, in accordance with certain embodiments. Such a method is illustrated as method 1000 and includes at least operations 1002-1010. A wireless network entity is configured to coordinate network-controlled operations. The wireless network entity includes at least one processor and is configured to perform at least operations 1002-1010.

At 1002, the wireless network entity receives a consent token from an AF such that the consent token is associated with a WTRU. In certain representative embodiments, 1002 may correspond to 520 of FIG. 5.

At 1004, the wireless network entity verifies, based on information from the AF, at least one of authenticity or integrity of the consent token. In certain representative embodiments, 1004 may correspond to at least one operation discussed in connection with FIG. 7.

At 1006, the wireless network entity receives a first request to perform a network-controlled operation. In certain representative embodiments, the first request is received from the AF or is received from a second wireless network entity. In certain representative embodiments, 1006 may correspond to at least 722 of FIG. 7.

At 1008, the wireless network entity determines that the consent token provides consent for the network-controlled operation to be performed by the WTRU.

At 1010, the wireless network entity transmits a second request indicating the consent token to the WTRU to perform the network-controlled operation. In certain representative embodiments, 1010 may correspond to 528 of FIG. 5.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), comprising:
generating a consent token associated with a network-controlled operation;
transmitting the consent token to a wireless network;
receiving, from the wireless network, a request indicating the consent token and whether to perform the network-controlled operation;
verifying whether the request indicating the consent token is valid; and
based on determining that the request is valid, performing the network-controlled operation.

2. The method of claim 1, wherein the network-controlled operation is related to any one or more of sensing, computing, data collection, artificial intelligence, or machine learning.

3. The method of claim 1, wherein the request further indicates metadata provided by a network entity.

4. The method of claim 3, wherein the consent token or the metadata provided by the network entity comprises any one or more of:
information of a type of network-controlled operation that the consent token is associated with;
configuration information associated with the WTRU;
target sensing service area related information;
time validity related information;
pricing related information;
acceptable data type information;
bandwidth availability information;
data storage configuration information;
data sharing configuration information;
a message authentication code, wherein the message authentication code is shared between the WTRU and the wireless network to verify at least one of integrity or authenticity of the consent token;
application function identifying information;
information specifying one or more networks the consent token is valid for;
WTRU identification information; or
service correlation identifying information, wherein the service correlation identifying information indicates one or more ongoing or previous network-controlled operations that the WTRU is suitable for.

5. The method of claim 4, wherein the message authentication code is verified by a shared key shared between the WTRU and the network entity, wherein the shared key is used to generate the message authentication code.

6. The method of claim 1, wherein the consent token comprises a digital signature generated by a hash function.

7. The method of claim 1, wherein verifying whether the request indicating the consent token is valid comprises verifying any one or more of:
reference information indicated in the request;
whether the consent token was received from a correct application function;
whether the consent token indicates correct public land mobile network identification information;
time information associated with the consent token;
whether the consent token is properly associated with the request;
authenticity of the consent token;
integrity of content of the consent token; or
whether the consent token is associated with the WTRU.

8. The method of claim 1, further comprising:
receiving a second request from the wireless network to revoke validity of the consent token; and
based on receiving the second request:
verifying the second request;
updating the consent token; and
halting performance of the network-controlled operation.

9. The method of claim 8, further comprising:
informing the wireless network that the WTRU will stop performing the network-controlled operation based on receiving the second request.

10. The method of claim 1, further comprising:
receiving a second request from the wireless network to update the consent token;
verifying the second request; and
updating the consent token based on the second request.

11. A wireless transmit/receive unit (WTRU) comprising processing circuitry and communication circuitry, the WTRU configured to
generate a consent token associated with a network-controlled operation;
transmit the consent token to a wireless network;
receive, from the wireless network, a request indicating the consent token and whether to perform the network-controlled operation;
verify whether the request indicating the consent token is valid; and
based on determining that the request is valid, perform the network-controlled operation.

12. The WTRU of claim 11, wherein the network-controlled operation is related to any one or more of sensing, computing, data collection, artificial intelligence, or machine learning.

13. The WTRU of claim 11, wherein the request further indicates metadata provided by a network entity.

14. The WTRU of claim 13, wherein the consent token or the metadata provided by the network entity comprises any one or more of:
information of a type of network-controlled operation that the consent token is associated with;
configuration information associated with the WTRU;
target sensing service area related information;
time validity related information;
pricing related information;
acceptable data type information;
bandwidth availability information;
data storage configuration information;
data sharing configuration information;
a message authentication code, wherein the message authentication code is shared between the WTRU and the wireless network to verify at least one of integrity or authenticity of the consent token;
application function identifying information;
information specifying one or more networks the consent token is valid for;
WTRU identification information; or
service correlation identifying information, wherein the service correlation identifying information indicates one or more ongoing or previous network-controlled operations that the WTRU is suitable for.

15. The WTRU of claim 11, wherein, when verifying whether the request indicating the consent token is valid, the WTRU is configured to verify any one or more of:
reference information indicated in the request;
whether the consent token was received from a correct application function;
whether the consent token indicates correct public land mobile network identification information;
time information associated with the consent token;
whether the consent token is properly associated with the request;
authenticity of the consent token;
integrity of content of the consent token; or
whether the consent token is associated with the WTRU.

16. The WTRU of claim 11, further configured to:
receive a second request from the wireless network to revoke validity of the consent token; and
based on receiving the second request:
verify the request;
update the consent token; and
halt performance of the network-controlled operation.

17. The WTRU of claim 16, further configured to:
inform the wireless network that the WTRU will stop performing the network-controlled operation based on receiving the second request.

18. The WTRU of claim 11, further configured to:
receive a second request from the wireless network to update the consent token;
verify the second request; and
update the consent token based on the second request.

19. A wireless network entity configured to coordinate network-controlled operations, the wireless network entity comprising at least one processor and configured to:
receive a consent token from an application function (AF), wherein the consent token is associated with a WTRU;
verify, based on information from the AF, at least one of authenticity or integrity of the consent token;
receive a first request to perform a network-controlled operation;
determine that the consent token provides consent for the network-controlled operation to be performed by the WTRU; and
transmit a second request indicating the consent token to the WTRU to perform the network-controlled operation.

20. The wireless network entity of claim 19, wherein the first request is received from the AF or is received from a second wireless network entity.
